(19) United States
(12) Patent Application Publication
(10) Pub. No.: US 2001/0046578 A1
(43) Pub. Date: Nov. 29, 2001

(54) Chair support systems and methods

(76) Inventor: Mark Frost, Anacortes, WA (US)

Correspondence Address: HUGHES & SCHACHT, P.S., Suite 1, 2801 Meridian St., Bellingham, WA, 98225-2412, US

(21) Appl. No.: 09/846,465

(22) Filed: Apr. 30, 2001

Related U.S. Application Data
(63) Continuation-in-part of application No. 09/357,789, filed on Jul. 21, 1999, now abandoned.
(60) Provisional application No. 60/093,624, filed on Jul. 21, 1998.

(51) Int. Cl. B32B 3/06

(52) U.S. Cl. 428/58; 428/192; 428/203; 428/100

(57) ABSTRACT

A chair support system having one or both of a chair pad assembly and a bearing assembly. The chair pad assembly comprises a structural layer and a surface layer for bearing loads of a chair or the bearing assembly attached to the chair. Preferably, a graphic image is formed between the structural layer and the surface layer and is visible through the surface layer. The bearing assembly comprises a structural layer for maintaining the bearing assembly in a substantially planar configuration and a lower layer for engaging either the floor or the surface layer of the chair pad assembly.

### RELATED APPLICATIONS

This is a continuation-in-part of U.S. Ser. No. 09/357,789, filed Jul. 21, 1999, which claimed priority of U.S. Provisional Application No. 60/093,624 filed Jul. 21, 1998.

### FIELD OF THE INVENTION

The present invention relates to systems and methods for supporting chairs and, more specifically, to such systems and methods that adapted to support a chair that must be moved within a small area on a carpeted surface.

### BACKGROUND OF THE INVENTION

In many settings, chairs are used in a manner that requires them to be moved frequently from one work position to one or more other closely adjacent work positions within an overall work area. For example, an office worker may work on a computer at a first work position, retrieve printed documents from a printer or facsimile located at a second work position, and work at a traditional desktop at a third work position. These three work positions are usually located adjacent to each other within a confined work area, such as the work area defined by a cubicle or by a U-shaped desk. The worker will move his or her chair among a number of work positions within the work area frequently during the workday.

Accordingly, chairs are commonly provided with wheels. The wheels reduce friction between the chair and the floor surface and thus facilitate movement between or among a plurality of work positions within the work area.

In many situations, the floor is carpeted and the floor surface is somewhat soft and compressible. This type of surface is not conducive to the smooth rolling of chair wheels. In addition, the relatively hard chair wheels will, over time, wear on the relatively soft carpet fibers within the work area, resulting in wear of the carpet, especially at the work positions. Accordingly, a carpet that is in good shape over most of its surface area may need to be replaced because of excessive wear in a small portion of its surface area.

To improve chair wheel operation and reduce uneven carpet wear, chair pads are commonly used. Chair pads are flat, relatively incompressible members that are placed on the floor surface within the work area. Most conventional chair pads are made of transparent plastic that is somewhat flexible but which is relatively incompressible. Conventional chair pads are manufactured in a small number of predetermined configurations such as rectangular and generally T-shaped.

Conventional chair pads are somewhat transparent so that they do not clash with the surrounding floor covering, but they are not designed to provide any positive aesthetic contribution to the work area. In addition, the plastic from which conventional chair pads are made becomes brittle over time and tends to crack, especially in heavily used work positions.

The need thus exists for improved chair pads and for chair support systems and methods that improve the ability of chairs to be moved along a floor surface within a work area.

### RELATED ART

A professional patentability search conducted on behalf of the Applicant turned up the following U.S. Pat. Nos.: 5,573,580 to Bartsch et al. and 5,387,461 to Kamiya et al. The Bartsh et al. patent discloses a coating for molds but has no relation to chair support systems and methods. The Kamiya et al. patent relates to a bearing material for enhanced sliding but also has no relation to chair support systems and methods.

### SUMMARY OF THE INVENTION

The invention is, in its broadest form, a chair support system or method. One aspect of the invention is the use of a laminate material having a substrate layer and a surface layer as a chair pad member. The substrate layer provides rigidity and maintains the chair pad member in a substantially horizontal orientation. The surface layer provides wear resistance. An image is formed between the substrate layer and the surface layer and is visible through the surface layer. A bearing assembly may also be used that attaches to the bottom of the chair and slides on a floor or the chair pad member.

### BRIEF DESCRIPTION OF THE DRAWING

FIG. 1 is a top, plan view of an exemplary chair pad of a chair support system of the present invention;

FIG. 2 is a partial section view of the chair pad of FIG. 1 taken along lines 2-2;

FIGS. 3 and 4 are additional exemplary chair pads similar to the chair pad of FIG. 1;

FIG. 5 is a perspective view of a chair support system employing a chair pad and an exemplary chair leg sheet;

FIG. 6 is a top plan view of the chair leg sheet depicted in FIG. 5; and

FIG. 7 is a partial section view of the chair leg sheet of FIG. 6 taken along lines 7-7;

FIG. 8 is a top plan view of a first embodiment of a modular chair support system of the present invention;

FIG. 9 is a top plan view of a second embodiment of a modular chair support system of the present invention;

FIG. 10 is a section view taken along lines 10-10 in FIGS. 8 and 9 showing an exemplary attachment system used by the modular chair support systems depicted therein;

FIG. 11 is a section view taken along lines 11-11 in FIGS. 8 and 9 showing an exemplary attachment system used by the modular chair support systems depicted therein; and

FIGS. 12-14 are partial section views similar to the view of FIG. 2 above of exemplary chair pads of the present invention.

### DETAILED DESCRIPTION OF THE PREFERRED EMBODIMENTS

Referring initially to FIG. 5, depicted therein is an exemplary chair support system 20 constructed in accordance with, and embodying, the principles of the present invention. The chair support system 20 is adapted to support a chair assembly 22 on a floor surface 24. The chair assembly 22 is or may be conventional and will not be described herein in detail. The present invention is of particular importance when the floor surface 24 is conventionally carpeted, but, as will be discussed below, provides benefits with other types of floor surfaces as well.

The exemplary chair support system 20 comprises a pad assembly 26a and a bearing assembly 28. The pad assembly 26a is a planar sheet that rests on the floor surface 24 and is located within a work area 29 having predetermined boundaries. The chair assembly 26a is moved within the work area 29, and a shape of the pad assembly 26a generally, but not exactly, corresponds to the shape of the work area 29.

The bearing assembly 28 is attached to the chair assembly 22 in place of wheels. The bearing assembly 28 slidingly engages the pad assembly 26a to allow the chair assembly 22 to be moved within the movement area.

As will become apparent before, the present invention may be embodied as one or the other of the pad assembly 26a and the bearing assembly 28 in addition to the combination of these assemblies 26a and 28.

Referring now to FIGS. 1 and 2, depicted therein is an exemplary pad assembly 26b that is constructed in the same manner as the chair pad 26a. The shapes of the pad assemblies 26a and 26b are different, but both shapes are conventional. In particular, in top plan view, the pad assembly 26a is generally square and has rounded corners; the pad assembly 26b is also generally square with rounded corners but, in addition, comprises a foot-well projection 30 adapted to extend into the foot-well of a desk so that the overall configuration is somewhat T-shaped.

The different shapes of the pad assemblies 26a and 26b are designed to generally correspond to the shape of the work area in which the pad assembly is to be used. However, because the shapes of the pad assemblies 26 are, in general, predetermined, these shapes may not exactly correspond to the boundaries of the work area at which a given pad assembly is used.

The details of construction of the exemplary pad assemblies disclosed herein will be described with reference to the pad assembly 26b, with the understanding that this discussion applies to the other pad assemblies discussed herein.

The pad assembly 26b comprises a pad member 32 and an edge guard 34. The pad member 32 defines a perimeter edge 36, an upper surface 38, and a lower surface 40. The edge guard 42 is secured to the pad member 32 about the perimeter edge 36. The perimeter edge 36 defines the shape of the pad assembly as discussed above.

The pad member 32 is a laminated member comprising a structural layer 42 and a surface layer 44.

In one preferred embodiment, the structural layer 42 is wood, laminated wood, or composite wood material that provides structural rigidity to the pad assembly 26b. In this case, the structural layer 42 will be formed of plywood or high density fiberboard that is approximately ¼ inches thick. A thin layer of material forming a moisture barrier may be applied to, adhered to, or formed on the lower surface 40 of the structural layer 42; malamine or other water resistant compatible material may be used as the moisture barrier.

In other embodiments, the structural layer 42 may be made of a relatively rigid material such as fiberglass, foam, or the like. In one preferred alternative embodiment, the structural layer is formed of a relatively rigid extruded foam. Again, a foam structural layer 42 may include a surface layer 42 and/or a moisture barrier.

The exemplary surface layer 44 is a clear plastic layer bonded to or formed on the structural layer 38, but other materials with similar physical properties may be appropriate. The exemplary surface layer 44 preferably includes aluminum oxide. Aluminum oxide makes this layer 44 highly durable and resistant to scratches, dents, and the like. Also, as will be discussed in further detail below, this surface layer 44 is clear and may be formed over a layer of print paper on which graphic elements of almost any type are printed.

A material suitable for use as the pad member 32 is commonly used to manufacture laminate flooring products that are currently popular and available in the marketplace. The material used in laminate flooring products comprises a sheet of plywood that forms a structural layer and, usually, a plastic layer on which is printed a photograph of a natural flooring material such as wood, stone, marble, and the like. This material is manufactured in four by eight foot stock sheets that, when used as a flooring product, are cut into relatively thin (i.e., two to six inches wide) flooring strips. Tongues are formed along one edge of these flooring strips and grooves are formed along the other edge. The flooring strips are then laid edge to edge and glued together with the grooves receiving the tongues to form a planar floor surface. Flooring strips of this type are available from Pergo, WilsonArt, and other companies.

The pad member 32 of the present invention differs from the flooring strips described above in that the four by eight stock sheet is not cut into thin strips that are subsequently glued together, but is instead cut into a final shape such as the shapes shown in FIGS. 1, 3, and 4.

After the stock sheet has been cut into a desired final shape, a substantially horizontal groove 46 may be formed around the entire perimeter edge 36 of the pad member 32. This perimeter groove 36 is cut into the structural layer 32 approximately halfway between the upper and lower surfaces 38 and 40.

The edge guard 34 is a vinyl extrusion having a tongue portion 48 and a bumper portion 50. The tongue portion 48 is sized and dimensioned to be received within the perimeter groove 46 formed in the pad member 32. So received, the tongue portion 48 holds the bumper portion 50 tightly against the perimeter edge 36. The bumper portion 50 absorbs shocks that might otherwise damage the pad member 32. The bumper portion 50 will also help to prevent moisture from seeping into the edges of and potentially delaminating the pad member 32. The bumper portion 50 also provides an aesthetically pleasing finished look to the perimeter edge 36 of the pad member 32. The edge guard 34 is optional and an acceptable chair pad assembly of the present invention may be manufactured without an edge guard.

The tongue portion 48 will frictionally engage the pad member 32 when received within the perimeter groove 46 to lock the edge guard 34 onto the pad member 32. But a thermosetting resin or other adhesive may be used to strengthen the bond between the edge guard 34 and the pad member 32.

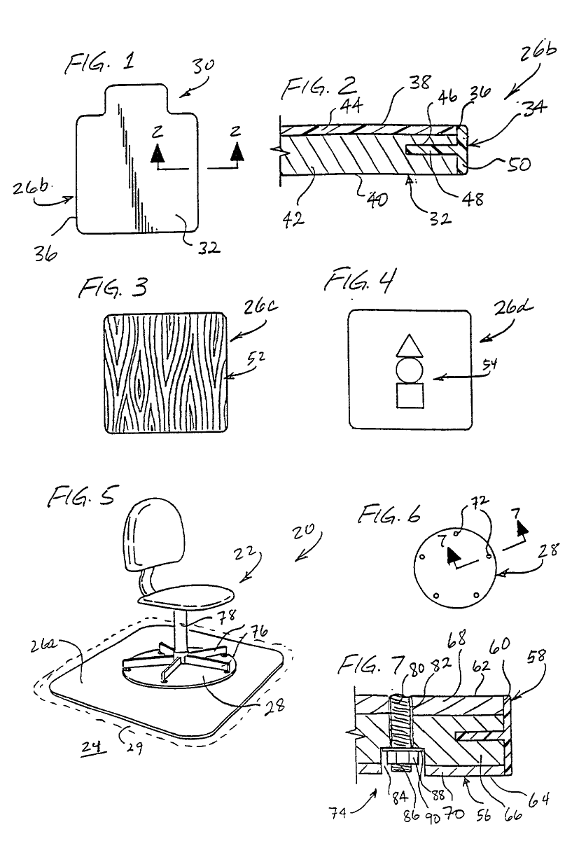

Referring now to FIGS. 3 and 4, depicted therein are two other exemplary pad assemblies 26c and 26d. These pad assemblies 26c and 26d are similar in shape to the pad assembly 26b shown in FIG. 5 and are constructed in the same basic manner as the pad assembly 26b.

FIGS. 3 and 4 show that the pad assemblies 26c and 26d have graphic elements 52 and 54, respectively, formed thereon. As shown, the graphic element 52 is a pictorial rendering of wood grain. The graphic element 54 is a rendering of an arbitrary design.

The graphic elements 52 and 54 are formed in the surface layer 44 of the pad member 32 by a photolithography process. This process is well known in the art of manufacturing the stock sheet described above. If the graphic element depicts a natural flooring material such as marble, stone, or wood the photolithography process starts with a high resolution photograph of the natural material which is then transferred to the surface layer 44 (e.g., the graphic element 52).

But it should be clear that any arbitrary graphic element may be transferred to the surface layer 44 (e.g., the graphic element 54). For example, photographs of objects other than natural building materials, company logos, artists' renderings, and the like may all be formed on the surface layer 44 of the pad member 32.

The ability to imprint the pad member 32 with any arbitrary graphic element provides the manufacturer with significant flexibility in the marketing of the pad assemblies 26. The manufacturer may offer a limited number of graphic elements to allow the customer to choose the aesthetic affect obtained. A company purchasing the pad assemblies 26 in large quantities may have its company logo imprinted thereon for advertising purposes. The pad assemblies 26 of the present invention thus provide a significant advantage over the prior art clear plastic chair pads.

In addition to allowing significant flexibility in aesthetic features, the pad assemblies 26 function at least as well as, if not better than, prior art chair pads. The structural layer 32 of the pad assemblies 26 adds significantly to the strength thereof and will be more resistant to the cracking to which all-plastic chair pads are prone. The surface layer 44 is highly resistant to dents and scratches and is easy to maintain.

And as discussed above, the chair pad assemblies 26 are of particular importance when the floor surface 24 is carpeted. Carpeted surfaces resist the movement of chair wheels; the chair pad assemblies 26 provide hard, smooth upper surfaces 38 on which chair wheels can easily roll. The chair pad assemblies 26 will also alleviate wear and tear on the carpet.

But the chair pad assemblies 26 of the present invention have use even if the floor surface is not carpeted. For example, tiled floors are discontinuous at the grouted junctures between tiles, and the chair pad assemblies 26 provide a smoother surface for chair wheels. Wood and vinyl floors do not impede the movement of wheeled chairs, but are relatively soft and can easily become dented, scratched, or otherwise worn by frequent movement of wheels thereover. These relatively soft surfaces are protected by the chair pad assemblies 26.

In one aspect, then, the present invention may simply be embodied as an improved chair pad assembly for use with conventional chair assemblies having wheels. But as will be discussed below, the chair pad assemblies 26 are particularly suited for use in the chair support system 20 briefly described above.

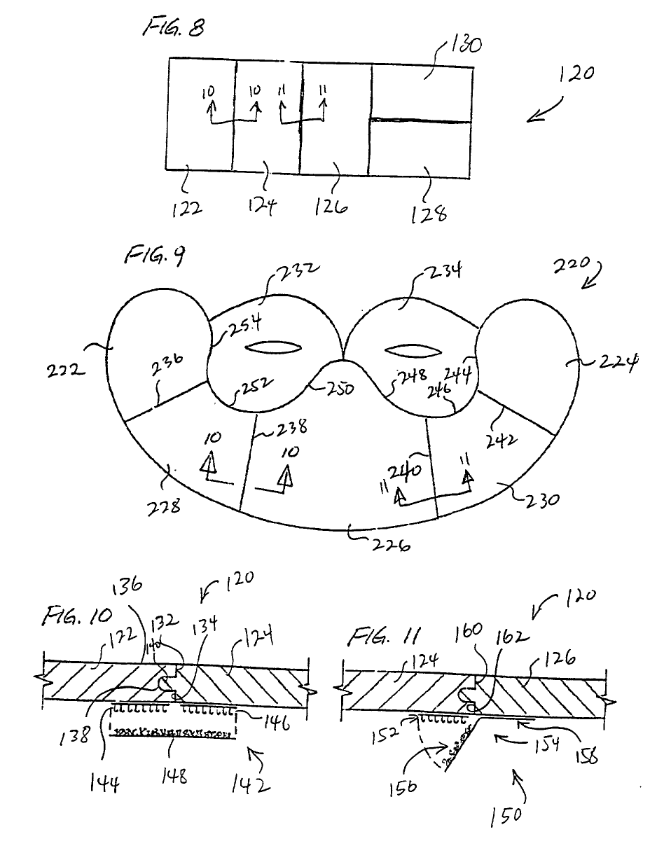

Turning now to FIGS. 6 and 7, the bearing assembly 28 will now be described in further detail. The bearing assembly 28 comprises a bearing member 56 and a bearing guard 58. The bearing member 56 has a perimeter edge 60, an upper surface 62, a lower surface 64. The bearing member 56 comprises a structural layer 66, an upper layer 68, and a lower layer 70. A series of holes 72 are formed in the bearing member 56.

The exemplary structural layer 66 is high density particle board, but other lightweight, strong materials, such as plywood, solid wood, fiberglass, and aluminum, may be used. The exemplary structural layer 66 is approximately one inches thick.

The exemplary upper layer 68 is melamine. Melamine is a hard, smooth, decorative surface that may be glued or otherwise bonded to the structural layer 66. The upper layer 68 need not be has hard and impervious as, for example, the upper surface 38 of the pad member 32. The primary requirement of the upper layer 68 is that will not be unduly worn by incidental contact with the user's feet, be relatively inexpensive to form, and be aesthetically pleasing. Melamine meets these requirements, as do other materials such as wood veneers, vinyl, and the like.

The exemplary lower layer 70 is formed of black aluminum oxide that is applied or adhered to the structural layer 66. Black aluminum oxide is very smooth and has a low coefficient of friction. Accordingly, the lower surface 64 of the support member 56 is very slippery. Other materials, such as polished metal, Teflon, polished wood, or the like, may be suitable for the formation of the lower layer 70.

The support assembly 28 is attached to the chair assembly 22 by bolt assemblies 74 that extend through the holes 72 into legs 76 of the chair assembly 22. Conventionally, office chair assemblies comprise five such legs 76 radially extending at equally spaced intervals from a central post 78, and wheels are attached at the distal ends of legs 76.

Conventional chair assemblies such as the chair assembly 22 may easily be adapted for use with the support assembly 28. In particular, the wheels of the chair assembly 22 may be removed or simply not provided in the first place. The holes 72 of the support assembly 28 are spaced at locations where the wheels would have been attached. The legs 76 are attached to the support assembly 28 at the holes 72 rather than to wheels.

The exact connection between the legs 76 and holes 72 may vary depending upon the circumstances. Usually, this connection will employ a bolt or stud 80 that extends through a first portion 82 of the holes 72 and into (but not through) a second portion 84 of the holes 72. The first hole portion 82 extends through the upper layer 68 and at least halfway through the structural layer 66 and is reduced diameter relative to the second hole portion 84.

The bolts or studs 80 are threaded as shown at 86 in FIG. 7. A washer 88 is placed over the bolt or stud 80, and a nut 90 engages the threaded portion 86 of the bolt or stud 80. The bolts or studs 80 engage the legs 76 such that tightening the nuts 90 will secure the legs 76 to the support assembly 28.

An alternative would be simply to fix a sleeve member (not shown) within each of the holes 72. Studs 80 on the chair would be received within the sleeves in the holes 72. The chair could be lifted up and off of the bearing member 56 because no nuts or the like are used, but lateral loads would be transferred to allow the chair assembly to be moved along the pad assembly 26.

Instead of a conventional chair assembly 22, a chair assembly may be custom-designed for use in the chair support system 20. For example, rather than having legs that are bolted to a structural layer of the support assembly 28, the structural layer 66 may be an aluminum plate that is integrally formed with or attached to the center post 78. In this case, the holes 72 and bolt assemblies 74 would not be required to attach the support assembly 28 to the chair assembly 22. The upper layer 68 may not be required in this example, and the lower layer may be formed of black aluminum oxide as described above or integrally formed with the structural layer 66 by polishing the lower surface thereof.

In use, the support assembly 28 rests on the pad assembly 26 with the lower surface 64 of the support assembly 28 engaging the upper surface 38 of the pad assembly 26. The properties of the lower layer 70 of the support member 56 and the upper layer 44 of the pad member 32 are such that the support assembly 28 will glide easily relative to the pad assembly 26, even with the chair assembly 22 attached to the support member 56 and a person sitting on the chair assembly 22. The person sitting in the chair assembly 22 may thus easily move around the area defined by the pad assembly 26. And because the bolts or studs 80 do not extend completely through the holes 72, they do not interfere with movement of the support assembly 28 relative to the pad assembly 26.

In comparison to wheels, the support assembly 28 operates at least as well and can be manufactured for significantly lower costs. While a chair assembly that is attached to the support assembly 28 would not move well on carpet without a pad assembly 26, it would work well on smooth, hard flooring surfaces such as those formed by the laminate flooring strips described above.

Referring now to FIG. 8, depicted therein is an alternative chair pad assembly 120 that is constructed in accordance with the principles of the present invention. The chair pad assembly 120 is comprises of discrete chair pad members 122, 124, 126, 128, and 130. These members are constructed in the same manner as the chair pad member 32 described above.

The discrete chair pad member 32 described above differs from the chair pad members 122-130 in that the shapes of the members 122-130 are predetermined to allow these members to be assembled modularly in different configurations. Accordingly, the chair pad members can be manufactured in a limited number of standard shapes and sizes and then can be put together to yield a larger arrangement that, as closely as possible, follows the contours of the work area in which the chair pad assembly 20 is to be used.

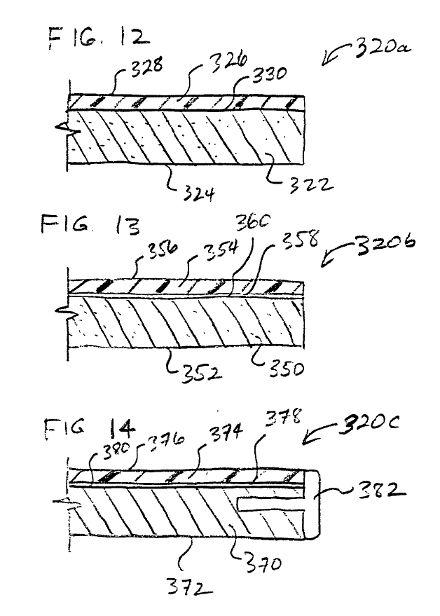

Another difference between the discrete chair pad member 32 and the chair pad members 122-130 of the assembly 120 is depicted in FIGS. 10 and 11. In particular, the chair pad member 122 defines an inner edge 132 and the chair pad member 124 defines an inner edge 134. These inner edges are adapted to be joined together such that the members 122 and 124 form a continuous chair surface 136 that extends across both of the chair pad members 122 and 124.

More specifically, the inner edge 132 of the pad member 122 has a groove 138 formed therein. The inner edge 134 of the pad member 124 has a projection 140 formed therein that is adapted to mate with the groove 138. With the projection 140 received within the groove 138 as shown in FIG. 10, relative vertical movement between the pad members 122 and 124 is inhibited.

Optionally, the chair pad assembly 120 may be provided with a fastening assembly 142. This fastener assembly 142 is a hook and loop fastener comprising first and second loop members 144 and 146 and a loop member 148. The loop portions 144 and 146 are glued or otherwise securely adhered or fastened to the chair pad members 122 and 124 along their respective inner edges 132 and 134. The loop portion 148 of the fastening assembly 142 is then arranged so that it overlays at least a portion of each of the hook portions 144 and 146 such that the hook portions 144 and 146 securely engage the loop portion 148. In this configuration, the fastening system 142 inhibits relative horizontal movement between the pad members 122 and 124.

Referring now for a moment to FIG. 11, another optional attachment assembly 150 is depicted therein. The attachment assembly comprises a hook portion 152 and a flap member 154. The flap member 154 comprises a loop portion 156 and a flap portion 158.

The hook portion 152 is glued or otherwise securely attached to the pad member 124 along a second interior edge 160 thereof. The flap portion 158 of the flap member 154 is glued or otherwise securely adhered to the pad member 126 along its interior edge 162 such that, when the edges 160 and 162 abut each other, the loop portion 156 is capable of overlapping at least a portion of the hook portion 152. When the loop portion 156 engages the hook portion 152, relative horizontal movement between the pad members 124 and 126 is substantially inhibited.

Referring now to FIG. 9, depicted therein is yet another modular chair pad assembly 220 that is in some respects similar to the chair pad assembly 120 described above. The chair pad assembly 220 comprises left end and right end pad members 222 and 224, a center pad member 226, intermediate pad members 228 and 230, and left and right desk members 232 and 234.

The chair pad assembly 220 can be broken down into the separate pieces 222-234 described above and thus can be stored and shipped in a smaller container.

Between the various members 222-234 of the chair pad assembly 220 are junctions 236-254. These junctions can be formed in the same way shown in FIGS. 10 or 11 such that vertical and horizontal movement between the various adjacent pad members is inhibited.

Referring now to FIG. 12, depicted therein is a chair pad assembly 320a constructed in accordance with, and embodying, the principles of the present invention. The chair pad assembly 320a comprises a structural layer 322 defining a lower surface 324 and an upper layer 326 defining an upper surface 328. In this case, the structural layer 322 is an extruded foam material that is relatively incompressible to allow smooth rolling or movement of a chair over the upper surface 328. Again, the upper layer 326 may be similar to the layer 44 described above and the lower surface 324 may have a moisture barrier formed thereon. If a graphic design is used, this design is preferably formed on an upper surface 330 of the structural layer 322 and is visible through the upper layer 326.

Referring now to FIG. 13, depicted therein is yet another exemplary chair pad assembly 320b constructed in accordance with, and embodying, the principles of the present invention. The chair pad assembly 320a comprises a structural layer 350 defining a lower surface 352 and an upper layer 354 defining an upper surface 356. The chair pad assembly 320b further comprises a design layer 358 laminated to an upper surface 360 of the structural layer 350. The exemplary structural layer 350 is also an extruded foam material that is relatively incompressible to allow smooth rolling or movement of a chair over the upper surface 356. Again, the upper layer 354 may be similar to the layer 44 described above and the lower surface 352 may have a moisture barrier formed thereon.

In the chair pad assembly 320b, the design layer 358 is a relatively thin layer of a material such as paper on which is formed an image by any technique such as photolithography. The design layer 358 is bonded to the upper surface 360 of the structural layer 350 before the upper layer 354 is bonded to the structural layer 352. The use of an intervening design layer 358 may increase the number of processes that may be used to form the design; the design layer 358 may also be adapted to yield a design having higher resolution than if the design is formed directly on the upper surface 360 of the structural layer 350.

Referring now to FIG. 14, depicted therein is yet another exemplary chair pad assembly 320c constructed in accordance with, and embodying, the principles of the present invention. The chair pad assembly 320b comprises a structural layer 370 defining a lower surface 372 and an upper layer 374 defining an upper surface 376. The chair pad assembly 320c further comprises a design layer 378 laminated to an upper surface 380 of the structural layer 370. The exemplary structural layer 380 is made of foam, plywood, particle board, or other material that allows smooth rolling or movement of a chair over the upper surface 378. Again, the upper layer 374 may be similar to the layer 44 described above and the lower surface 372 may have a moisture barrier formed thereon.

In the chair pad assembly 320c, the design layer 378 is a relatively thin layer of a material such as paper on which is formed an image by any technique such as photolithography. The design layer 378 is bonded to the upper surface 380 of the structural layer 370 before the upper layer 374 is bonded to the structural layer 372. The use of an intervening design layer 378 may increase the number of processes that may be used to form the design; the design layer 378 may also be adapted to yield a design having higher resolution than if the design is formed directly on the upper surface 380 of the structural layer 370.

In addition, the exemplary chair pad assembly 320c comprises an edge guard 382 similar to the edge guard 34 described above. The edge guard 382 may be attached to the perimeter edge of the structural layer 370 using an suitable technique, but the use of a mechanical tongue and groove along with an adhesive is preferred.

From the foregoing, it should be clear that the present invention may be embodied in forms other than those described above.

I claim:

1. A chair support system for supporting a chair assembly on a floor within a work area having predetermined boundaries, the chair support system comprising:
a chair pad assembly comprising
a structural layer for maintaining the chair pad assembly in a substantially planar configuration during normal use, and
a surface layer for engaging the chair assembly to facilitate movement of the-chair assembly relative to the chair pad assembly; wherein
the chair pad assembly defines a shape that generally corresponds to the predetermined boundaries of the work area; and
a graphic image is formed below an upper surface of the surface layer such that the graphic image is visible through at least a portion of the surface layer.

2. A chair support system as recited in claim 1, where the graphic image is a photolithographic image.

3. A chair support system as recited in claim 1, where the surface layer includes a wear material for reducing wear of the surface layer.

4. A chair support system as recited in claim 3, where the wear material is aluminum oxide.

5. A chair support system as recited in claim 1, in which the chair pad assembly further comprises an edge guard attached to a perimeter edge of the pad member.

6. A chair support system as recited in claim 1, in which the chair pad assembly further comprises a design layer interposed between the structural layer and the surface layer, where a design is formed on the design layer and is visible through the surface layer.

7. A chair support system as recited in claim 1, where the graphic image is a photolithographic image formed on the design layer.

8. A chair support system as recited in claim 1, in which the structural layer is formed of a material selected from the group consisting of plywood, particle board, and foam.

9. A chair support system as recited in claim 1, in which the design is formed on an upper surface of the structural layer and is visible through the upper layer.

10. A chair support system as recited in claim 1, in which moisture barrier is formed on a lower surface of the structural layer.

11. A chair support system as recited in claim 10, in which the moisture barrier is formed of melamine.

12. A chair support system as recited in claim 1, in which the chair pad assembly comprises a plurality of pad members, with each pad member being joined along an interior edge to an adjacent pad member to define a pad surface that extends across the plurality of pad members.

13. A chair support system as recited in claim 12, in which each of the chair pad members comprises a first interior edge and a second interior edge, where the first and second interior edges of adjacent chair pad members are contoured to engage each other and inhibit relative vertical movement between the adjacent chair pad members.

14. A chair support system as recited in claim 12, in which the chair pad assembly further comprises fastening means for joining the interior edges of adjacent chair pad members to inhibit horizontal movement between the adjacent chair pad members.

15. A chair support system as recited in claim 14, in which the chair pad assembly further comprises fastening means for joining the interior edges of adjacent chair pad members to inhibit horizontal movement between the adjacent chair pad members.

16. A chair support system as recited in claim 14, in which the fastening means comprises a hook/loop fastener comprising a hook portion adhered to one of the adjacent chair pad members and a loop portion adhered to another of the adjacent chair pad members such that the loop portion extends below and engages the hook portion.

17. A chair support system for supporting a chair assembly on a floor, the chair support system comprising a bearing assembly rigidly attached to the chair assembly, the bearing assembly comprising a structural layer for maintaining the bearing assembly in a substantially planar configuration and a lower layer for engaging the floor.

18. A chair support system as recited in claim 17, in which the lower layer of the bearing assembly comprises a friction-reducing material to reduce friction between the bearing assembly lower layer and the floor.

19. A chair support system as recited in claim 18, in which the friction-reducing material is black aluminum oxide.

20. A chair support system as recited in claim 17, in which the bearing assembly further comprises an upper layer formed on the opposite side of the structural layer from the lower layer.
